(19) United States
(12) Patent Application Publication
(10) Pub. No.: US 2016/0340768 A1
(43) Pub. Date: Nov. 24, 2016

(54) HYBRID AIR PLASMA SPRAY AND SLURRY METHOD OF ENVIRONMENTAL BARRIER DEPOSITION

(71) Applicants: Joshua Lee Margolies, Niskayuna, NY (US); Herbert Chidsey Roberts, III, Simpsonville, SC (US); Don Mark Lipkin, Niskayuna, NY (US); Glen Harold Kirby, Liberty Township, OH (US); Nicholas Edward Antolino, Schenectady, NY (US)

(72) Inventors: Joshua Lee Margolies, Niskayuna, NY (US); Herbert Chidsey Roberts, III, Simpsonville, SC (US); Don Mark Lipkin, Niskayuna, NY (US); Glen Harold Kirby, Liberty Township, OH (US); Nicholas Edward Antolino, Schenectady, NY (US)

(21) Appl. No.: 15/050,751

(22) Filed: Feb. 23, 2016

Related U.S. Application Data
(62) Division of application No. 13/565,946, filed on Aug. 3, 2012.

(51) Int. Cl. C23C 4/12; F01D 5/28

(52) U.S. Cl. CPC C23C 4/12; F01D 5/288; F01D 5/282; F05D 2220/32; F05D 2240/30; F05D 2300/6033; F05D 2230/312; F05D 2300/15

(57) ABSTRACT

A bond layer may be applied to the substrate of an article and a first layer may be applied to the bond layer by thermal spray. A second layer may be applied above the first layer by slurry coating.

### TECHNICAL FIELD

The present disclosure relates to environmental barrier coatings and in particular to methods and systems for applying environmental barrier coatings on ceramic matrix composite articles.

### BACKGROUND

Gas turbines are internal combustion engines that compress gases, forcing the gases into a combustion chamber where heat is added to increase the volume of the gases. The combusted gases are then directed towards a turbine to extract the energy generated by the expanding gases. Gas turbines have many practical applications, including providing propulsion in jet engines and electricity generation in industrial power generation systems.

The accelerating and directing of gases within a gas turbine are often accomplished using rotating blades. Extraction of energy is typically accomplished by forcing expanded gases from the combustion chamber towards gas turbine blades that are spun by the force of the expanded gases exiting the gas turbine through the turbine blades. Due to the high temperatures of the exiting gases, gas turbine components must be constructed to endure extreme operating conditions. While gas turbine components are commonly constructed from metals or metallic alloys, more advanced materials, such as intermetallics, ceramics, and ceramic matrix composites are being developed. When using these and other advanced materials in constructing components and articles that may be subjected to extreme environmental conditions, coatings may be applied to provide added thermal and environmental protection to the article or component to increase its durability.

### BRIEF DESCRIPTION OF THE INVENTION

In an exemplary non-limiting embodiment, an article is disclosed that may include a substrate. A bond layer may be applied to the substrate and a first layer may be applied to the bond layer by thermal spray. A second layer may be applied above the first layer by slurry coating.

In another exemplary non-limiting embodiment, a method is disclosed for coating an article. A bond layer may be applied to a substrate of the article. A first layer may be applied to the bond layer by thermal spray. A second layer may be applied above the first layer by slurry coating.

In another exemplary non-limiting embodiment, a gas turbine component may include a substrate and a bond layer applied to the substrate. The component may further include a first layer comprising a first rare earth disilicate applied to the bond layer by thermal spray, a second layer comprising barium strontium aluminosilicate applied to the first layer by thermal spray, and a third layer comprising a second rare earth disilicate applied to the second layer. The component may also include a fourth layer comprising a rare earth monosilicate applied to the third layer by slurry coating.

The foregoing summary, as well as the following detailed description, is better understood when read in conjunction with the drawings. For the purpose of illustrating the claimed subject matter, there is shown in the drawings examples that illustrate various embodiments; however, the invention is not limited to the specific systems and methods disclosed.

### BRIEF DESCRIPTION OF THE DRAWINGS

These and other features, aspects, and advantages of the present subject matter will become better understood when the following detailed description is read with reference to the accompanying drawings, wherein:

FIG. 1 is a non-limiting example of coatings applied to an article.

FIG. 2 is another non-limiting example of coatings applied to an article.

FIG. 3 is another non-limiting example of coatings applied to an article.

FIG. 4 is another non-limiting example of coatings applied to an article.

FIG. 5 is another non-limiting example of coatings applied to an article.

### DETAILED DESCRIPTION OF THE INVENTION

In an embodiment, an environmental barrier coating (EBC) may be applied to an article, such as a gas turbine blade, that may be constructed from a ceramic matrix composite (CMC), such as a SiC—SiC composite. The article may be coated with a bond coating that may function as an oxidation barrier and promote bonding with the EBC layers. An EBC may help protect the article from the effects of environmental threats such as hot gas, water vapor, and oxygen that may come in contact with the article while it is in use. For example, a gas turbine blade in service in an operating gas turbine may be exposed to such extreme environmental conditions. An EBC may be applied as several layers of various materials, and one or more of these layers may be silicate-based. Each EBC layer may be intended to serve at least one function, such as, but not limited to, providing a thermal barrier, providing a water vapor recession barrier, providing a interlayer reaction barrier, providing a water vapor barrier, and providing a corrosion barrier. In the embodiments of the present disclosure, the materials in each layer may be or include any material, including ceramic material, silicon, and silicide.

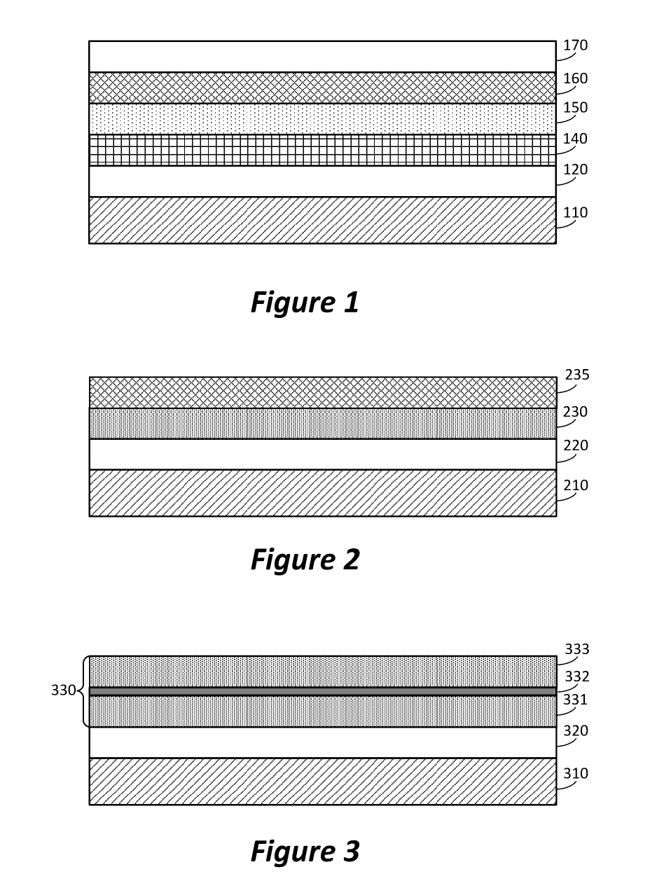

FIG. 1 illustrates an example coating that may be applied to an article constructed from a CMC. Substrate 110 of the CMC article may be coated with bond layer 120 that may serve as a primary oxidation barrier and assist in bonding the other EBC layers to substrate 110. In an embodiment, bond layer 120 may be a silicon-based bond coat or a silicide-based bond coat. EBC layer 140 may be applied on bond layer 120. Additional EBC layers 150, 160, and 170 may further be applied over EBC layer 140. These layers may serve at least one function, such as, but not limited to, providing a thermal barrier, providing a water vapor recession barrier, providing a interlayer reaction barrier, providing a water vapor barrier, and providing a corrosion barrier. Any number of EBC layers may be applied to substrate 110 and any other article or surface disclosed herein, using any means and methods, and any material may be used for any article, bond layer, and EBC layer disclosed herein, including bond layer 120, EBC layers 140, 150, 160, and 170 and for substrate 110. All such embodiments are contemplated as within the scope of the present disclosure.

Each of layers 120, 140, 150, 160, and 170 may be applied using various methods and means. In an embodiment, a thermal spray method, such as air plasma spray, may be used to apply one or more of the layers. Thermal spray methods are especially effective at applying a silicon-based bond coat, such as layer 120, and thick deposits of any of the overlying EBC layers. However, applying thick layers of an EBC using a plasma spray method may result in coatings having undesirably high roughness for the turbine application. Furthermore, plasma spray may produce EBC coating defects that may result in a lack of EBC hermeticity and/or reduced adhesion following heat treatment. Such defects may arise due to strains that the as-plasma-sprayed coatings may experience upon crystallization and, in some cases, additional solid-state transformations.

While a silicon-based bond coat such as layer 120 may be applied using other means, such as a slurry coating process, slurry coating may be less suited for bond coat application due to the need for at least one high-temperature, non-oxidizing post-deposition sintering cycle. In addition to higher manufacturing costs, the high-temperature sintering cycle for slurry bond coats may debit the mechanical properties of the substrate material. Moreover, by using slurry coating for each layer, multiple dip, dry, and sintering heat treatment cycles may be needed to achieve the desired layer thickness. However, slurry coating may produce smooth coatings that do not require subsequent surface finishing and therefore avoid the accompanying risk of removing too much material from the surface.

In an embodiment, slurry coatings may be applied on top of thermal sprayed coatings to take advantage of the unique benefits of each coating application method. Note that as used herein, slurry coating includes any slurry coating means and methods, including, but not limited to, slurry dip coating, slurry spray coating, and slurry-based electrophoretic deposition.

Depositing slurry on top of thermal sprayed layers may produce slurry layers that fail to fully densify due to a loss of a portion of the sintering aid by transport into the thermal sprayed layers. Therefore, in another embodiment, sintering aids may be included below the slurry layer so as to assist the attainment of the desired density in the slurry EBC layers. The sintering aids may be introduced as an addition to the thermal spray powder, such as by using pre-alloyed powders or physical blends incorporating the sintering aid components. Alternatively, or in addition, sintering aids can be incorporated as a post-spray deposit, such as via a solution deposit, to create a reservoir of sintering agent in the sprayed coating.

As use herein, “sintering aids” and “sintering agents” may include any sintering aid, including, but not limited to carbonyl iron, Fe₂O₃, and Al₂O₃. Sintering aids and agents as described herein may also include elemental iron, aluminum, boron, nickel, cobalt, manganese, tin, copper, gallium, titanium, magnesium, calcium, strontium, barium, lithium, sodium, potassium, rubidium, cesium, any compound containing these elements, and any mixture of these elements or compounds. Sintering aids and agents as described herein may also include compounds that include oxides such as gallium oxide, nickel oxide, cobalt oxide, manganese oxide, tin oxide, copper oxide, titanium oxide, boron oxide, magnesium oxide, calcium oxide, strontium oxide, barium oxide, lithium oxide, sodium oxide, potassium oxide, rubidium oxide, and cesium oxide. Sintering aids and agents as described herein may also include hydroxides, carbonates, oxalates, acetates, acetyl acetates, ethoxides, propoxides, chlorides, sulfates, carbides, nitrides, as well as silicides of iron, aluminum, boron, nickel, cobalt, manganese, tin, copper, gallium, titanium, magnesium, calcium, strontium, barium, lithium, sodium, potassium, rubidium, and cesium. Sintering aids and agents as described herein may also include any compound containing at least one of iron, aluminum, boron, nickel, cobalt, manganese, tin, copper, gallium, titanium, magnesium, calcium, strontium, barium, lithium, sodium, rubidium, and cesium along with at least one of yttrium, scandium, lanthanum, cerium, praseodymium, neodymium, samarium, europium, gadolinium, terbium, dysprosium, holmium, erbium, thulium, ytterbium, lutetium, and at least one of oxygen, silicon, chlorine, carbon, and nitrogen. Sintering aids and agents as described herein may also include phosphorous and any compound containing phosphorous. All such embodiments are contemplated as within the scope of the present disclosure.

In some embodiments, chemical vapor deposition may be used to effectively apply a silicon-based bond coat. In other embodiments, a combination of a thermal spray method and a chemical vapor deposition method may be used to apply a silicon-based bond coat. In an embodiment, illustrated in FIG. 2, bond layer 220 may be applied to substrate 210 using thermal spray methods, chemical vapor deposition methods, or a combination thereof. Bond layer 220 may be composed of silicon and/or silicide. Substrate 210 may be constructed of silicon, SiC, Si3N4, metal silicides (e.g., Mo—Si, Nb—Si, W—Si), carbon, composites therefrom (e.g., SiC/SiC CMC, C/C composite, MoSi2-based composites, and Nb5Si3-based composites), and any combination thereof.

One or more layers may be applied above layer 220 to act as moisture barriers, thermal barriers, and/or volatilization barriers. In an embodiment, the next layer, layer 230, may include a rare earth disilicate, such as, but not limited to, Ytterbium disilicate and Yttria-Ytterbia disilicate. In an embodiment, a particular or minimum thickness may be desired to achieve the desired durability and service interval for the article to which this layer may be applied. To achieve this thickness, layer 230 may be applied using multiple slurry coatings to build up the layer. In an alternative embodiment, a base deposit of a rare earth disilicate may be applied at layer 230 using plasma spray, and then a slurry coating may be further applied at layer 235 to fill in any defects, such as micro-cracks or pinholes in the sprayed deposit and thus produce the desired hermeticity. In an embodiment, the slurry coating at layer 235 may be a low viscosity slurry coating.

To help densify slurry applied layer 235, any portion of layer 230 applied using thermal spray may include a sintering agent. The sintering agent may assist in preventing layer 235 from losing sintering aid upon firing via migration into the spray deposit. The sintering agent may be incorporated into the thermal spray powder used in applying layer 230 using any method disclosed herein. In one such embodiment, the sintering agent may be pre-alloyed with the spray powder, while in another embodiment the sintering agent may be blended into the spray powder before coating application. Alternatively, the sintering agent may be applied contemporaneously with the spray powder but from a separate spraying implement.

In another embodiment, illustrated in FIG. 3, bond layer 320 may be applied to substrate 310 using thermal spray methods, chemical vapor deposition methods, or a combination thereof. Bond layer 320 may be composed of silicon and/or silicide. Substrate 310 may be constructed of silicon, SiC, Si3N4, metal silicides (e.g., Mo—Si, Nb—Si, W—Si), carbon, composites therefrom (e.g., SiC/SiC CMC, C/C composite, MoSi2-based composites, and Nb5Si3-based composites), and any combination thereof.

In this embodiment, layer 330 may be applied over bond layer 320 to act as a moisture barrier and for prevention and mitigation of volatilization. Here, rather than, or in addition to, integrating a sintering agent into a spray powder used in applying thermal sprayed portion 331 and/or slurry applied portion 333, sintering agent 332 may be applied as a solution over thermal sprayed portion 331 of layer 330, after thermal sprayed portion 331 of layer 330 is applied over layer 320, but before the application of slurry applied portion 333 of layer 330.

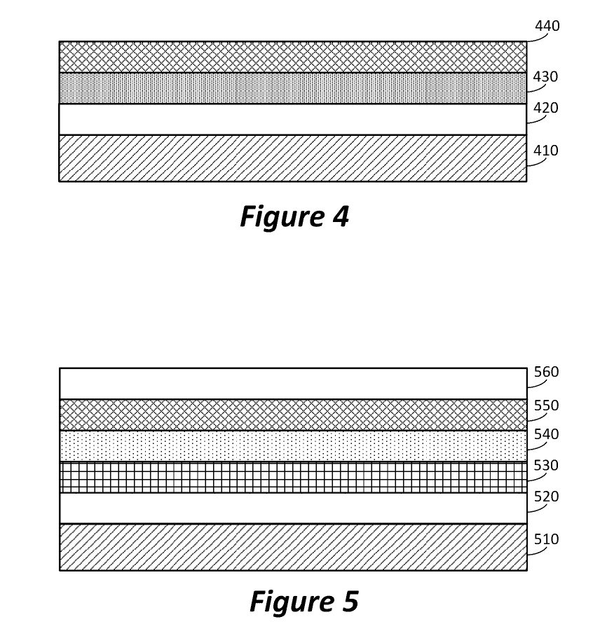

In another embodiment, illustrated in FIG. 4, bond layer 420 may be applied to substrate 410 using thermal spray methods, chemical vapor deposition methods, or a combination thereof. Bond layer 420 may be composed of silicon and/or silicide. Substrate 410 may be constructed of silicon, SiC, Si3N4, metal silicides (e.g., Mo—Si, Nb—Si, W—Si), carbon, composites therefrom (e.g., SiC/SiC CMC, C/C composite, MoSi2-based composites, and Nb5Si3-based composites), and any combination thereof. Layer 430 may be a rare earth disilicate layer, such as layer 230 of FIG. 2 or layer 330 of FIG. 3. Either or both of layers 420 and 430 may be applied using a means other than a slurry deposition process. In this embodiment, layer 440 may include a rare earth monosilicate, such as, but not limited to, Yttrium monosilicate. In an embodiment, layer 440 may be the outermost layer, and therefore layer 440 may be applied using a slurry method to achieve a desired density and surface finish. As with all embodiments set forth herein, the slurry coating process may also permit deposition of a rare earth silicate without the melting that may take place were the layer applied using thermal spray. By avoiding the melting of the rare earth silicate, the rare earth silicate may not experience defect-inducing volume changes that may be observed during post-coating heat treatment as may be experienced in some plasma spray applications.

In another embodiment, illustrated in FIG. 5, bond layer 520 may be applied to substrate 510 using thermal spray methods, chemical vapor deposition methods, or a combination thereof. Bond layer 520 may be composed of silicon and/or silicide. Substrate 510 may be constructed of silicon, SiC, Si3N4, metal silicides (e.g., Mo—Si, Nb—Si, W—Si), carbon, composites therefrom (e.g., SiC/SiC CMC, C/C composite, MoSi2-based composites, and Nb5Si3-based composites), and any combination thereof. Layer 530 may be a rare earth disilicate layer, such as layer 230 of FIG. 2 or layer 330 of FIG. 3, but may be wholly applied using thermal spray methods.

Layer 540 may include barium strontium aluminosilicate (BSAS) to assist with hermeticity and may be applied using thermal spray methods. Layer 550 may be another rare earth disilicate layer such as layer 230 of FIG. 2 or layer 330 of FIG. 3, and may be applied using thermal spray methods, slurry methods, or any combination thereof set forth herein. Layer 550 may contain the same rare earth disilicate as layer 530, a different rare earth disilicate, a mixture of BSAS and a rare earth disilicate, a mixture of BSAS and a rare earth monosilicate, or a combination thereof. Layer 550 may include a sintering agent that may be applied in any manner disclosed herein, including in a thermal spray applied portion of layer 550 and/or as a solution applied between two sub-layers of layer 550 as set forth above. Layer 560 may be the outermost layer and may applied using slurry coating. Layer 560 may be substantially a rare earth monosilicate, such as a mixture of a rare earth monosilicate and a rare earth disilicate or a mixture of a rare earth monosilicate and a rare earth oxide.

Note that, for any embodiment disclosed herein, a sintering agent may be added below a slurry layer where the lower layer may be applied using thermal spray. The sintering agent may be applied using any method or means described herein, including by integrating the sintering agent into the thermal spray powder of the lower layer and by applying the sintering agent as a solution over the thermal spray applied layer prior to applying the slurry layer.

As will be appreciated by those skilled in the art, the use of a combination of thermal spray applied layers and slurry applied layers provides many advantages to EBCs, including achieving a desired thickness cost effectively by using thermal spray methods for lower layers and achieving a desired surface finish and density by using slurry coating for the outermost layer or outer layers. With the present embodiments, there may be no need to mechanically finish the surface of a coated article, thereby avoiding operations that could excessively thin or even remove the outer layer entirely in local areas. This has the advantages of reducing process steps and maintaining the coating protective function. Additionally, slurry deposited outer layers are not subject to crystallization and crystalline phase transformations upon heat treatment, therefore avoiding the source of those defects in the underlying layers resulting from volume change accompanying such transformations. The presently disclosed embodiments may increase the lifespan of EBC layers and therefore of devices and apparatuses that incorporate articles and components configured with such EBC layers, such as gas turbine blades, while being simple and cost effective to implement.

This written description uses examples to disclose the subject matter contained herein, including the best mode, and also to enable any person skilled in the art to practice the invention, including making and using any devices or systems and performing any incorporated methods. The patentable scope of this disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. (canceled)

2. (canceled)

3. (canceled)

4. (canceled)

5. (canceled)

6. (canceled)

7. (canceled)

8. A method of coating an article comprising:
applying a bond layer to a substrate of the article;
applying a first layer above the bond layer by thermal spray; and
applying a second layer above the first layer by slurry coating.

9. (canceled)

10. (canceled)

11. The method of claim 8, further comprising applying a third layer to the second layer by slurry coating.

12. The method of claim 11, further comprising applying a third layer to the first layer by thermal spray, wherein applying the second layer comprises applying the second layer to the third layer by slurry coating.

13. The method of claim 8, wherein the first layer comprises a rare earth disilicate.

14. The method of claim 8, wherein the second layer comprises a rare earth monosilicate.

15. (canceled)

16. (canceled)

17. (canceled)

18. (canceled

19. (canceled)

20. (canceled)
